(19) United States
(12) Patent Application Publication
(10) Pub. No.: US 2015/0215196 A1
(43) Pub. Date: Jul. 30, 2015

(54) PACKET TRANSMISSION METHOD AND APPARATUS

(71) Applicant: Huawei Technologies Co., Ltd., Shenzhen (CN)

(72) Inventors: Bo Zeng, Shenzhen (CN); Hui Liao, Shenzhen (CN)

(21) Appl. No.: 14/681,626

(22) Filed: Apr. 8, 2015

Related U.S. Application Data
(63) Continuation of application No. PCT/CN2013/078722, filed on Jul. 3, 2013.

(30) Foreign Application Priority Data
Oct. 22, 2012 (CN) 201210404177.9

(51) Int. Cl. H04L 12/755; H04L 29/12

(52) U.S. Cl. CPC H04L 45/021; H04L 61/2503; H04L 61/6068

(57) ABSTRACT

The present invention discloses a packet transmission method and apparatus, relates to the field of communications technologies, and is invented for implementing independent QoS management and traffic statistics performed by an operator, and optimizing and configuring air interface resources. The method includes: selecting, by a transport layer, a routing path for a received payload according to a preset relational table; encapsulating, by the transport layer, the payload into a packet according to the routing path selected for the payload; and sending, by the transport layer, the packet to a network layer according to the routing path, so that the network layer sends the packet to a target host system. The present invention is mainly applied to a process of data routing in a TCP/IP five-layer model.

### CROSS-REFERENCE TO RELATED APPLICATION

This application is a continuation of International Application No. PCT/CN2013/078722, filed on Jul. 3, 2013, which claims priority to Chinese Patent Application No. 201210404177.9, filed on Oct. 22, 2012, both of which are hereby incorporated by reference in their entireties.

### TECHNICAL FIELD

The present invention relates to the field of communications technologies, and in particular, to a packet transmission method and apparatus.

### BACKGROUND

With the development of communications technologies, the number of operators and the quantity of communication services keep increasing. When a user equipment (UE for short) needs to communicate with another UE, an operator to which the UE belongs sends communication content to the other UE by using a base station. When multiple operators share a resource of a base station, the base station needs to divide an IP (Internet Protocol) address inside the base station, for example, to separate IP routing domains of two operators by using a virtual routing and forwarding (VRF for short) technology, which can ensure that a conflict of IP addresses does not occur when a same IP address exists in the IP routing domains of the two operators. Otherwise, a conflict of the IP addresses occurs, which causes resending or missing of an IP packet, and leads to a communication barrier between the UEs.

Generally, an IP routing domain in a base station is divided into an IP routing domain of a wholesale operator and IP routing domains of multiple retail operators. In a TCP/IP (Transmission Control Protocol/Internet Protocol) five-layer network structure, after an application layer selects an IP routing domain corresponding to an IP packet of an operator, a transport layer distributes the IP packet to a corresponding IP routing domain in a network layer according to the selection of the application layer, and performs transmission by using the IP routing domain corresponding to the operator in the network layer. For transmission of communication content by using an IP routing domain when multiple operators share a resource of a base station, two communication manners exist inside the base station. One communication manner is that a wholesale operator and multiple retail operators share a same air interface resource in the application layer, and both IP packets of the wholesale operator and the retail operator are transmitted in the network layer by using an IP routing domain of the wholesale operator. The other communication manner is that a wholesale operator and multiple retail operators separately use a respective air interface resource in the application layer, and separately perform transmission in the network layer by using a respective IP routing domain.

In a process of implementing the foregoing packet transmission, the inventor finds that the prior art at least has the following problems: A wholesale operator and multiple retail operators share an IP routing domain allocated to the wholesale operator, which causes that the retail operator cannot perform QoS (quality of service) management according to a priority of an IP packet, a communication speed between base stations and a communication speed between a base station and a controller are reduced, the wholesale operator cannot perform traffic statistics on the IP routing domain of the wholesale operator, and the retail operator bears an extra service burden; and air interface resources are isolated from each other, that is, air interface resources cannot be shared, which causes that configuration efficiency of air interface resources are reduced.

### SUMMARY

Embodiments of the present invention provide a packet transmission method and apparatus, which can isolate traffic for an operator, and implement QoS management of the traffic for the operator and traffic statistics for the operator. In addition, multiple operators share a same air interface resource, which can improve configuration efficiency of air interface resources.

According to a first aspect, an embodiment of the present invention provides a packet transmission method, where the method includes:

selecting, by a transport layer, a routing path for a received payload according to a preset relational table;

encapsulating, by the transport layer, the payload into a packet according to the routing path; and

sending, by the transport layer, the packet to a network layer according to the routing path, so that the network layer sends the packet to a target host system.

In a first possible implementation manner, with reference to the first aspect, the method further includes: receiving, by the transport layer, a first mapping table, where the first mapping table is used to indicate a correspondence between a source Internet Protocol IP address with a source routing domain number corresponding to the source IP address and a destination IP address with a destination routing domain number corresponding to the destination IP address;

determining, by the transport layer, whether the source routing domain number is equal to the destination routing domain number, and when a determining result is that the source routing domain number is equal to the destination routing domain number, setting, by the transport layer, the source routing domain number or the destination routing domain number as an actual routing domain number; and

adding, by the transport layer, the source IP address, the destination IP address, and the actual routing domain number into the relational table, so as to establish a routing path, and add a path number for the routing path.

In a second possible implementation manner, with reference to the first aspect, the method further includes: selecting, in the relational table by the transport layer according to a preset algorithm and the path number, a routing path for routing the payload to serve as an actual routing path.

According to a second aspect, an embodiment of the present invention provides a host system, where the host system includes:

a receiver, configured to receive a payload;

a selector, configured to select, according to a preset relational table, a routing path for the payload received by the receiver;

an encapsulator, configured to encapsulate, according to the routing path selected by the selector for the payload, the payload received by the receiver into a packet; and

a sender, configured to send the packet encapsulated by the encapsulator to a router, so that the router sends the packet to a target host system.

In a first possible implementation manner of the second aspect, the receiver is further configured to receive a first mapping table, where the first mapping table is used to indicate a correspondence between a source IP address with a source routing domain number corresponding to the source IP address and a destination IP address with a destination routing domain number corresponding to the destination IP address; and

the host system further includes: a determiner, configured to determine whether the source routing domain number and the destination routing domain number that are received by the receiver are equal;

a setter, configured to : when the source routing domain number received by the receiver is equal to the destination routing domain number, and a determining result of the determiner is that the source routing domain number is equal to the destination routing domain number, set the source routing domain number or the destination routing domain number received by the receiver as an actual routing domain number; and

an adder, configured to add, into the relational table, the source IP address and the destination IP address that are received by the receiver, and the actual routing domain number that is set by the setter, so as to establish a routing path, and add a path number for the routing path.

In a second possible implementation manner of the second aspect, the selector specifically includes: a sub-selector, configured to select, in the relational table according to a preset algorithm and the path number that is added by the adder, a routing path for routing the payload to serve as an actual routing path.

The packet transmission method and apparatus provided in the embodiments of the present invention can select a routing path for payloads of a wholesale operator and a retail operator, encapsulate the payloads into packets, and send the packets to a network layer, so that the network layer sends the packets to a target host system. Because no dedicated routing domain is designated for an operator, the wholesale operator and the retail operator are not limited by a routing domain. Compared with a first technical solution in the prior art, operators can perform QoS management according to a priority of an IP packet, the operators can independently perform traffic statistics, and improve a communication speed between a host system and a controller and a communication speed between host systems, and the retail operator no longer bears an extra service burden. In addition, an application layer uniformly receives payloads of operators, and the application layers is not isolated according to the operators, Compared with a second technical solution in the prior art, the operators can use a same air interface resource, thereby improving configuration efficiency of air interface resources.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic diagram of an interior of a base station in the prior art;

FIG. 2 is a method flowchart of a packet transmission method according to an embodiment of the present invention;

FIG. 3 is a method flowchart of another packet transmission method according to an embodiment of the present invention;

FIG. 4 is a method flowchart of still another packet transmission method according to an embodiment of the present invention;

FIG. 5 is a schematic structural diagram of a first host system according to an embodiment of the present invention;

FIG. 6 is a schematic structural diagram of a second host system according to an embodiment of the present invention;

FIG. 7 is a schematic structural diagram of a third host system according to an embodiment of the present invention;

FIG. 8 is a schematic structural diagram of a fourth host system according to an embodiment of the present invention;

FIG. 9 is a schematic structural diagram of a fifth host system according to an embodiment of the present invention;

FIG. 10 is a schematic structural diagram of a sixth host system according to an embodiment of the present invention; and

FIG. 11 is a schematic structural diagram of a seventh host system according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

A host system described in the present invention includes, but is not limited to, a base station, an access point (AP for short), or a multimedia access device. In subsequent embodiments of the present invention, description is provided by using a base station as the host system, and in a practical application, the host system should not be limited to the base station.

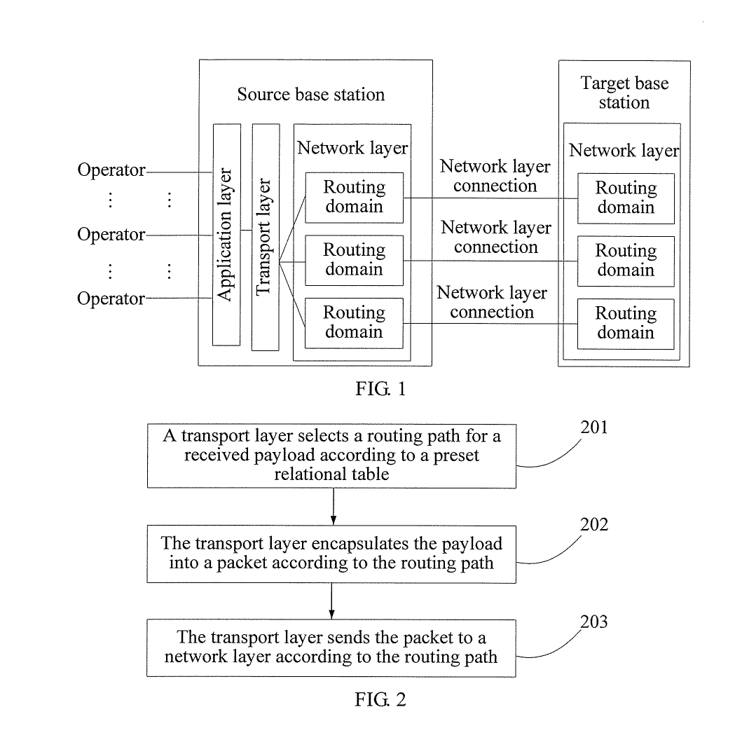

To conveniently describe the embodiments of the present invention, a packet receiving process based on the embodiments of the present invention is introduced first. As shown in FIG. 1, applications layer in a source base station are not isolated for operators, and the application layers are used to receive payloads of different operators; a transport layer is used to transmit, control, and encapsulate the payloads received by the application layer; network layers are isolated to form multiple routing domains according to a virtual routing and forwarding technology, and the payloads encapsulated by the transport layer are sent (routed), by using the routing domains, to a corresponding routing domain in a target base station. Base stations are interconnected by using the network layer. In a Transmission Control Protocol/Internet Protocol (TCP/IP for short) five-layer network model, the foregoing application layer is an application layer; in an Open System Interconnection (OSI for short) seven-layer network model, the foregoing application layer is a combination of an application layer, a presentation layer, and a session layer. In the description of subsequent embodiments, the foregoing application layer refers to the application layer in the TCP/IP five-layer model or the combination of the application layer, the presentation layer, and the session layer in the OSI seven-layer network model. The transport layer in the embodiments of the present invention includes, but is not limited to, a Stream Control Transmission Protocol (SCTP for short) layer in the transport layer.

### Embodiment 1

This embodiment of the present invention provides a packet transmission method. As shown in FIG. 2, the method includes the following steps:

Step 201: A transport layer selects a routing path for a received payload according to a preset relational table.

The payload is data content sent by a wholesale operator and/or at least one retail operator; for example, in a process of a voice call, two UEs determine that voice content is a payload. The relational table can be manually entered or manually imported by a system administrator, or may also be automatically generated by means of control and management. It is determined that the selected routing path is an actual routing path used for transmitting the payload, and the actual routing path corresponds to a routing domain using an actual routing domain number to identify a transmitted packet.

Step 202: The transport layer encapsulates the payload into a packet according to the routing path.

The foregoing packet may be, but is not limited to, an IP packet.

Step 203: The transport layer sends the packet to a network layer according to the routing path.

The transport layer sends, according to an actual routing domain number corresponding to the routing path selected by step 201, the IP packet encapsulated by step 202 to a routing domain corresponding to an actual routing domain number in the network layer, so that the network layer sends the packet to a target base station. The network layer sends the IP packet to the target base station by using the routing domain corresponding to the actual routing domain number.

In the packet transmission method provided in this embodiment of the present invention, a transport layer can select a routing path for payloads of a wholesale operator and a retail operator, encapsulate the payloads into packets, and send the packets to a network layer, so that the network layer sends the packets to a target base station. Compared with a first technical solution in the prior art, in the technical solution of the present invention, a routing domain is selected by selecting a routing path, so that transmission performed on the packets by the wholesale operator and the retail operator is not limited by a routing domain, thereby unifying priority routing policies of routing domains, which therefore avoids that a routing domain of the wholesale operator routes a packet of the retail operator according to a priority routing policy of the wholesale operator when the packet of the retail operator is routed by using the routing domain of the wholesale operator, and therefore every operator independently performs QoS management and traffic statistics. In addition, because an application layer is not isolated according to an operator, it is achieved that an air interface resource in the application layer can be shared. Compared with a second technical solution in the prior art, the operators can use a same air interface resource, thereby improving configuration efficiency of air interface resources.

### Embodiment 2

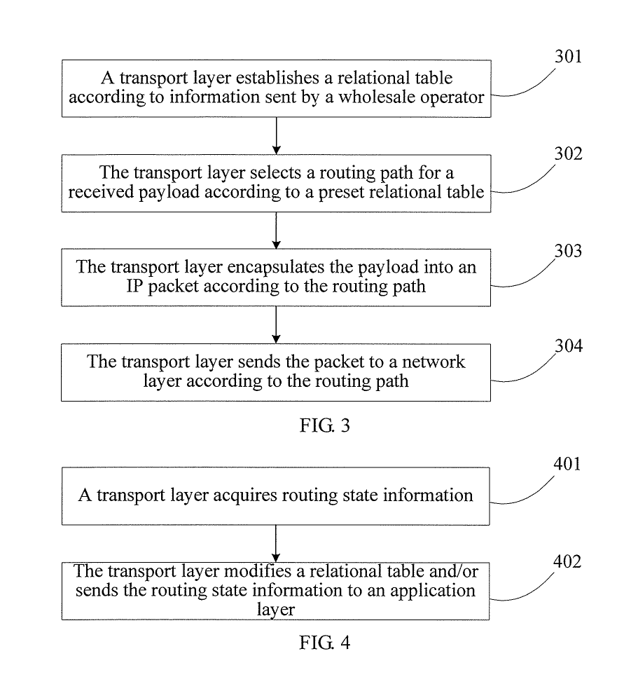

As further description of Embodiment 1, this embodiment of the present invention further provides a packet transmission method. As shown in FIG. 3, the method includes the following steps:

Step 301: A transport layer establishes a relational table according to information sent by a wholesale operator.

The relational table may be manually entered or manually imported by a system administrator, or may also be automatically generated by means of control and management. Therefore, when the relational table is manually entered or manually imported, this step can be ignored. The information sent by the wholesale operator is specifically manifested as a first mapping table. An operator providing a data transmission resource is a wholesale operator, and an operator borrowing a data transmission resource is a retail operator. When transmitting a packet, the wholesale operator or a mobile operator needs to acquire a correspondence between an IP address and a routing domain number by using a first mapping table managed by the wholesale operator, and perform data transmission by using the data transmission resource provided by the wholesale operator. For example, when China Unicom (China United Network Communications Group Co., Ltd) needs to borrow a host system of China Mobile to perform data transmission, China Mobile is a wholesale operator, and China Unicom is a retail operator. Both China Mobile and China Unicom need to obtain the correspondence between an IP address and a routing domain number by using a first mapping table provided by China Mobile, and perform data transmission by using a data transmission resource provided by China Mobile, for example, a network and a telecommunications device of China Mobile.

Specifically, the transport layer receives the first mapping table sent by the wholesale operator, where entries in each row in the first mapping table are used to indicate a correspondence between a source IP address with a source routing domain number corresponding to the source IP address and a destination IP address with a destination routing domain number corresponding to the destination IP address.

The first mapping table is shown in Table 1. The first mapping table includes four attributes: a source IP address, a source routing domain number corresponding to the source IP address, a destination IP address, and a destination routing domain number corresponding to the destination IP address. In entries in a first row of the first mapping table, the source IP address is “192.168.0.1”, the source routing domain number corresponding to the source IP address is “1”, the destination IP address is “192.168.0.2”, and the destination routing domain number corresponding to the destination IP address is “1”. “192.168.0.1”, “1”, “192.168.0.2”, and “1” are used as a group of correspondences, and are stored in the entries in the first row of the first mapping table.

TABLE 1

| | | | Routing domain |
|---|---|---|---|
| | Routing domain | | number |
| | number | | corresponding to |
| Source IP | corresponding to | Destination | destination IP |
| address | source IP address | IP address | address |
| 192.168.0.1 | 1 | 192.168.0.2 | 1 |
| 192.168.0.1 | 1 | 192.168.0.2 | 2 |
| 192.168.0.1 | 2 | 192.168.0.2 | 2 |
| 192.168.1.3 | 1 | 192.168.1.5 | 1 |
| . | . | . | . |
| . | . | . | . |
| . | . | . | . |

The transport layer determines whether the source routing domain number is equal to the destination routing domain number, and when a determining result is that the source routing domain number is equal to the destination routing domain number, the transport layer sets the source routing domain number or the destination routing domain number as an actual routing domain number. In this embodiment of the present invention, for the entries in the first row in Table 1, both the source routing domain number and the destination routing domain number are 1, the transport layer sets an actual routing domain number corresponding to the entries in the first row to 1; for entries in a second row in Table 1, the source routing domain number is 1, the destination routing domain number is 2, and therefore, the transport layer does not set a corresponding actual routing domain number for the entries in the second row.

The transport layer adds the source IP address, the destination IP address, and the actual routing domain number into the relational table, so as to establish a routing path, and add a path number for the routing path. The relational table is shown in Table 2, and the relational table includes three attributes: a source IP address, a destination IP address, and an actual routing domain number. In entries in a first row of the relational table, the source IP address is “192.168.0.1”, the actual routing domain number is “1”, and the destination IP address is “192.168.0.2”. The transport layer uses “192.168.0.1”, “1”, and “192.168.0.2” as a piece of path information, and stores the path information in the entries of the first row of the relational table.

TABLE 2

| Path | Source IP | Destination IP | Actual routing domain |
|---|---|---|---|
| number | address | address | number |
| 1 | 192.168.0.1 | 192.168.0.2 | 1 |
| 2 | 192.168.0.1 | 192.168.0.2 | 2 |
| 3 | 192.168.1.3 | 192.168.1.5 | 1 |
| . | . | . | . |
| . | . | . | . |
| . | . | . | . |
| 10 | 192.168.9.9 | 192.168.9.8 | 2 |

As a basis for setting the relational table, the first mapping table includes all source IP addresses that may exist and a destination IP address that may interwork with the source IP address. The source IP address and the source routing domain number appear in pair, and the destination IP address and the destination routing domain number appear in pair. The transport layer determines the reachability of a source IP address and a destination IP address by determining whether a source routing domain number corresponding to the source IP address in the first mapping table is equal to a destination routing domain number corresponding to the destination IP address.

Specifically, as shown in Table 1, in the entries in the first row of the first mapping table, the source IP address is “192.168.0.1”, the source routing domain number corresponding to the source IP address is “1”, the destination IP address is “192.168.0.2”, and the destination routing domain number corresponding to the destination IP address is “1”. In the entries in the second row of the first mapping table, the source IP address is “192.168.0.1”, the source routing domain number corresponding to the source IP address is “1”, the destination IP address is “192.168.0.2”, and the destination routing domain number corresponding to the destination IP address is “2”. When the transport layer determines the first group of correspondences (that is, the entries in the first row), because the source routing domain number “1” corresponding to the source IP address is equal to the destination routing domain number “1” corresponding to the destination IP address, the transport layer determines that the source IP address “192.168.0.1” and the destination IP address “192.168.0.2” are reachable. In contrast, when the transport layer determines a second group of correspondences (that is, the entries in the second row), because the source routing domain number “1” corresponding to the source IP address is unequal to the destination routing domain number “2” corresponding to the destination IP address, the transport layer can determine that the source IP address “192.168.0.1” and the destination IP address “192.168.0.2” are unreachable.

When the source routing domain number is equal to the destination routing domain number, it is determined that the source IP address and the destination IP address are reachable; meanwhile, the source routing domain number or the destination routing domain number is used as an actual routing domain number, and the actual routing domain number, the source IP address, the destination IP address, and the path number, which are used as a piece of path information together, are added into the relational table. The path number may be a sequential number, or may also be a random number. A complete relational table can be constructed by repeating the foregoing steps. The complete relational table includes one or more pieces of path information, and the path information is used to indicate relevant information of a routing path corresponding to the path information. An actual routing domain number can be used to differentiate a same source IP address and a same destination IP address in different routing domains. Therefore, relevant information of all reachable paths in all routing domains is recorded in the relational table.

Specifically, in the relational table shown in Table 2, a first piece of path information corresponds to the entries of the first row in Table 1. After it is determined that the source IP address “192.168.0.1” and the destination IP address are reachable, the transport layer uses the source IP address “192.168.0.1”, the destination IP address “192.168.0.2”, and the actual routing domain number “1” together as a piece of path information, stores the path information in the entries of the first row in the relational table, and sets a path number for the piece of path information, such as “1”. When it is determined in the foregoing that the source routing domain number is unequal to the destination routing domain number, for example, for the entries of the second row shown in Table 1, the transport layer does not store, in the relational table, information in the entries of the second row shown in Table 1.

Step 302: The transport layer selects a routing path for a received payload according to a preset relational table.

The transport layer selects, in the relational table according to a preset algorithm and the path number, a routing path for routing the payload to serve as an actual routing path for routing the payload.

Specifically, after receiving payloads of operators, an application layer sends the payloads to the transport layer. After receiving the payloads from the application layer, the transport layer determines, in the relational table according to the preset algorithm, a piece of path information as relevant information of the actual routing path for routing the payload. The foregoing preset algorithm may be, but is not limited to, an algorithm in a hash algorithm.

For the foregoing scenario, if the preset algorithm is a division and remainder algorithm in the hash algorithm, the relational table includes 10 pieces of path information, the path number is a sequential number, and a second-level unit of time in which the transport layer receives the payload is used as a keyword of the hash algorithm. When receiving a payload at the 13th second of some time, the transport layer divides a keyword 13 by 10 by using the division and remainder algorithm, and keeps a remainder 3 as a calculation result. In this case, the transport layer selects path information that is in the relational table and has a path number of “3” as the relevant information of the actual routing path for routing the payload, that is, to select path information in which a path number is “3”, a source IP address is “192.168.1.3”, a destination IP address is “192.168.1.5”, and an actual routing domain number is “1”.

Step 303: The transport layer encapsulates the payload into an IP packet according to the routing path.

The IP packet is a kind of packet, and for conveniently describing this embodiment of the present invention, description is provided by using a packet as an IP packet hereinafter.

Specifically, the transport layer encapsulates the payload into the IP packet, where a source IP address in the IP packet is a source IP address corresponding to the actual routing path, and a destination IP address in the IP packet is a destination IP address corresponding to the actual routing path. That is, the transport layer encapsulates the three, namely, the source IP address and the destination IP address that are in the path information selected by step 302, together with the payload into the IP packet.

For the foregoing scenario, the transport layer encapsulates the source IP address “192.168.1.3” and the destination IP address “192.168.1.5” in the path information having a path number of “3” together with the payload into the IP packet.

Step 304: The transport layer sends the packet to a network layer according to the routing path.

Specifically, the transport layer sends, according to the actual routing domain number corresponding to the actual routing path, the encapsulated IP packet to a routing domain corresponding to the actual routing domain number in the network layer, so that the network layer sends the packet to a target base station by using the routing domain.

The actual routing domain number corresponding to the actual routing path can be obtained from the path information corresponding to the actual routing path determined by step 302, and the transport layer sends, according to the actual routing domain number, the IP packet encapsulated by step 303 to the routing domain corresponding to the actual routing domain number in the network layer. The network layer sends the received IP packet to the target base station by using the actual routing path in the routing domain.

For the foregoing scenario, if the network layer includes two routing domains in total, whose routing domain numbers are “1” and “2” respectively. For path information of which a path number is odd in the relational table, an actual routing domain number of the path information is “1”; for path information of which a path number is even in the relational table, an actual routing domain number of the path information is “2”. For the foregoing IP packet, a result obtained in the transport layer by using the hash algorithm is 3, that is, a path number of the path information is “3”. Because “3” is an odd number, an actual routing domain number corresponding to the IP packet is “1”, and the transport layer sends the IP packet to a routing domain whose routing domain number is “1” in the network layer. The network layer sends the IP packet to the target base station by using an IP address, which is “192.168.1.3” in a routing domain whose routing domain number is “1”, as a source IP address.

Further, when an application layer monitors a transmission state of a payload or maintains and tests a transmission state of a whole network, the application layer needs to acquire relevant information of the network by using the transport layer or invoking relevant information stored in the transport layer. Referring to FIG. 4, the method further includes:

Step 401: A transport layer acquires routing state information.

Specifically, the transport layer acquires first routing state information that is used by the network layer to send an IP packet, where the first routing state information is used to indicate whether a routing path for routing the IP packet is reachable; and/or, the transport layer instructs the network layer to send a testing IP packet to the target base station, and acquire second routing state information that is used by the network layer to send the testing IP packet, where the second routing state information is used to indicate whether a routing path for routing the testing IP packet is reachable.

When an IP packet sent by a source base station carries a feedback instruction (where the feedback instruction is used to instruct the target base station to return, to the source base station, information used for indicating whether the IP packet reaches the target base station, that is, routing state information), the target base station sends another IP packet including routing state information of the IP packet to the source base station. The routing state information is the first routing state information. In this case, after receiving the other IP packet, a network layer of the source base station sends the other IP packet to a transport layer of the source base station; and/or, after the source base station sends a testing IP packet used for testing a reachable state of the routing path to the target base station, the network layer of the source base station receives another testing IP packet including routing state information of the testing IP packet, where the other testing IP packet is a response testing packet fed back by the target base station according to the testing packet sent by the source base station, and sends the other testing IP packet to the transport layer of the source base station. Information that is in the other testing IP packet and is used to indicate a path reachable state is the second routing state information. To sum up, the transport layer may acquire first routing state information of a routing path for routing an IP packet by using another IP packet including routing state information of the IP packet, may also acquire second routing state information of the routing path by autonomously sending a testing IP packet and receiving another testing IP packet including routing state information of the testing IP packet, and may also acquire the first routing state information and the second routing state information at the same time.

Step 402: The transport layer modifies a relational table and/or sends the routing state information to an application layer.

The transport layer reports, to an upper layer of the transport layer, the destination IP address corresponding to the routing path, the actual routing domain number corresponding to the routing path, and a reachable state of the routing path according to first routing state information and/or second routing state information; and/or, the transport layer modifies the relational table according to the first routing state information and/or the second routing state information, where the modifying the relational table includes: deleting a routing path in the relational table or adding a routing path to the relational table. The upper layer of the transport layer corresponds to the application layer.

When the application layer acquires the first routing state information, namely, information about that an IP packet is reachable, from the transport layer, the transport layer sends the first routing state information acquired from the network layer to the application layer. When the application layer needs to test the reachability of a routing path, the transport layer sends the second routing state information, namely, information about that a single routing path is reachable, acquired in step 401 to the application layer. When the application layer needs to test the reachability of all routing paths in a whole network, the transport layer can acquire reachable state information of all the routing paths in the whole network by repeating the step of acquiring the second routing state information in step 401, and send routing state information of all the routing paths to the application layer.

When the transport layer finds, by determining, that first routing state information of a routing path is unreachable, the transport layer deletes path information corresponding to the routing path from the relational table, adds the path information to a candidate table, and sends a retransmission request to the application layer at the same time.

When the transport layer finds, by determining, that second routing state information of a routing path is unreachable, the transport layer deletes path information corresponding to the routing path from the relational table, and adds the path information to the candidate table.

When the first routing state information or the second routing state information is reachable, the relational table is not modified.

When the first routing state information is unequal to the second routing state information, the transport layer sends a testing IP packet used for returning the second routing state information, determines a reachable state of the routing path again, and correspondingly modifies the relational table according to the second routing state information acquired at time closest to a current moment in a time sequence. The modified relational table is stored in the transport layer to be conveniently invoked by the application layer.

For path information in the candidate table, if the second routing state information acquired by the transport layer by using step 401 is reachable, the path information is added to the relational table and then the path information in the candidate table is deleted; if the second routing state information acquired by the transport layer by using step 402 is unreachable, the path information is not modified. The candidate table is used to record unreachable path information obtained after testing, and as a part of all routing paths, the candidate table participates in testing the reachability of all the routing paths of the whole network each time.

The transport layer in this embodiment of the present invention is an SCTP layer, and in an actual application, the transport layer should not be only limited to the SCTP layer.

In the packet transmission method provided in this embodiment of the present invention, a transport layer can select a routing path for payloads of a wholesale operator and a retail operator, encapsulate the payloads into packets, and send the packets to a network layer, so that the network layer sends the packets to a target base station. Because when the routing path is selected for the payloads, a routing path of any routing domain instead of a routing path of a dedicated routing domain can be selected for routing, that is, no dedicated routing domain is designated for an operator, the wholesale operator and the retail operator are not limited by a routing domain. Because the operator has no dedicated routing domain, priority routing policies of routing domains can be unified, thereby avoiding that a routing domain of the wholesale operator routes a packet of the retail operator according to a priority routing policy of the wholesale operator when the packet of the retail operator is routed by using the routing domain of the wholesale operator, which therefore can implement independent QoS management and traffic statistics performed by the operators. Meanwhile, more desirable resource space is provided for communication between base stations and communication between a base station and a controller, thereby improving a communication speed between base stations and a communication speed between a base station and a controller. The retail operator can autonomously control and detect a packet transmission condition by selecting a path by the transport layer, and for a packet which does not belong to a routing range of a routing domain of the retail operator, the retail operator no longer bears an extra service, that is, an extra service burden of the retail operator is reduced. In addition, because the transport layer can select the routing path for the payloads of the wholesale operator and the retail operator, so that an application layer can differentiate different routing domains in the network layer without dividing the application layer, so as to achieve an objective of selecting different routing domains for routing, the application layer can simultaneously receive the payload of the wholesale operator and receive the payload of the retail operator, that is, the application layer is not isolated according to an operator, so that an air interface resource in the application layer can be shared. Compared with a second technical solution in the prior art, the operators can use a same air interface resource, thereby improving configuration efficiency of air interface resources. Meanwhile, this embodiment of the present invention further provides an implementation manner of detecting the reachability of the routing path, thereby achieving technical effects of enhancing a management function of the transport layer, improving invoking efficiency of the application layer, and improving the packet transmission reachability.

This embodiment of the present invention is described by using a base station as a host system. When the host system is an AP or a multimedia access device, an implementation manner of packet transmission can be implemented by referring to an implementation manner in which the base station is used as the host system and with reference to features of the AP or the multimedia access device, and details are not described in this embodiment of the present invention again.

### Embodiment 3

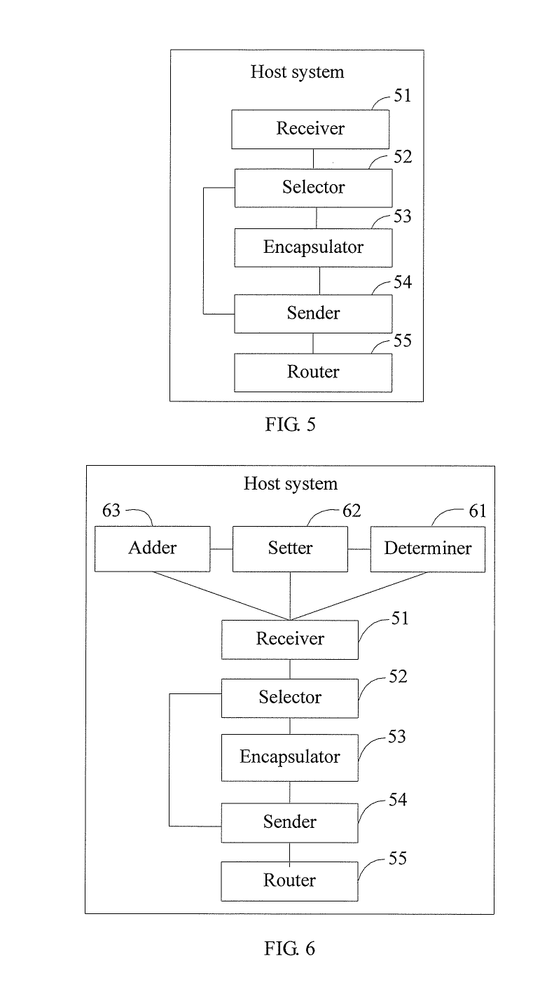

Referring to the implementation of the foregoing method embodiments, this embodiment of the present invention provides a host system, which is used to implement the foregoing method embodiments. As shown in FIG. 5, the host system includes: a receiver 51, a selector 52, an encapsulator 53, a sender 54, and a router 55.

The receiver 51 is configured to receive a payload.

The selector 52 is configured to select, according to a preset relational table, a routing path for the payload received by the receiver 51, where the payload is data content sent by a wholesale operator or at least one retail operator.

The relational table may be manually entered or manually imported by a system administrator, or may also be automatically generated by means of control and management.

The encapsulator 53 is configured to encapsulate, according to the routing path selected by the selector 52 for the payload, the payload received by the receiver 51 into a packet.

The packet encapsulated by the encapsulator 53 may be, but is not limited to, an IP packet.

The sender 54 is configured to send the packet encapsulated by the encapsulator 53 to the router 55.

The router 55 is configured to send, to a target host system, the packet sent by the sender 54.

The sender 54 sends, according to an actual routing domain number corresponding to the routing path selected by the selector 52, the IP packet encapsulated by the encapsulator 53 to the router 55. The router 55 sends, to the target host system by using a routing domain corresponding to the actual routing domain number, the IP packet sent by the sender 54.

Further, as shown in FIG. 6, the receiver 51 is further configured to receive a first mapping table sent by the wholesale operator, where the first mapping table is used to indicate a correspondence between a source IP address with a source routing domain number corresponding to the source IP address and a destination IP address with a destination routing domain number corresponding to the destination IP address; and the host system further includes a determiner 61, a setter 62, and an adder 63.

The determiner 61 is configured to determine whether the source routing domain number and the destination routing domain number that are received by the receiver 51 are equal.

The setter 62 is configured to: when a determining result of the determiner 61 is that the source routing domain number is equal to the destination routing domain number, set the source routing domain number or the destination routing domain number received by the receiver 51 as an actual routing domain number.

The adder 63 is configured to add, into the relational table, the source IP address and the destination IP address that are received by the receiver 51, and the actual routing domain number that is set by the setter 62, so as to establish a routing path, and add a path number for the routing path.

Specifically, the determiner 61 determines whether a source routing domain number and a destination routing domain number that are in each correspondence in the first mapping table received by the receiver 51 are equal. When the source routing domain number is equal to the destination routing domain number, the setter 62 sets the source routing domain number or the destination routing domain number as the actual routing domain number. The adder 63 adds, into the relational table, the source IP address and the destination IP address that are received by the receiver 51, and the actual routing domain number that is set by the setter 62, so as to establish a routing path, and add a path number for the routing path.

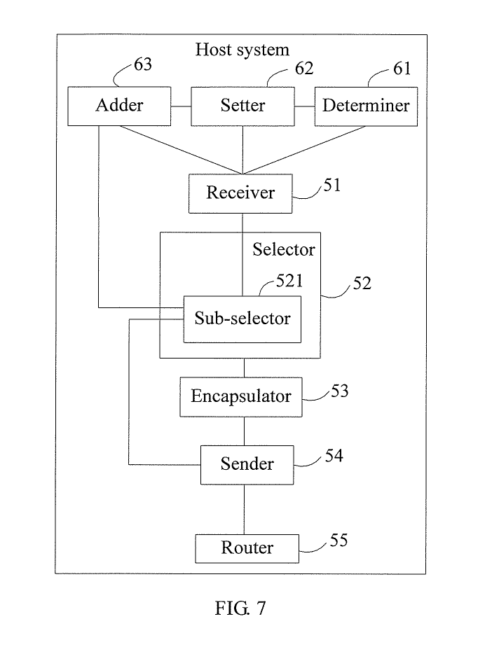

Further, as shown in FIG. 7, the selector 52 further includes a sub-selector 521, where the sub-selector 521 is configured to select, in the relational table according to a preset algorithm, a routing path for routing the payload to serve as an actual routing path.

The sub-selector 521 determines, according to the preset algorithm and in the relational table after addition is performed by the adder 63, a piece of path information as relevant information of the actual routing path for routing the payload, so that the encapsulator 53 encapsulates the payload received by the receiver 51. The preset algorithm may be, but is not limited to, an algorithm in the hash algorithm.

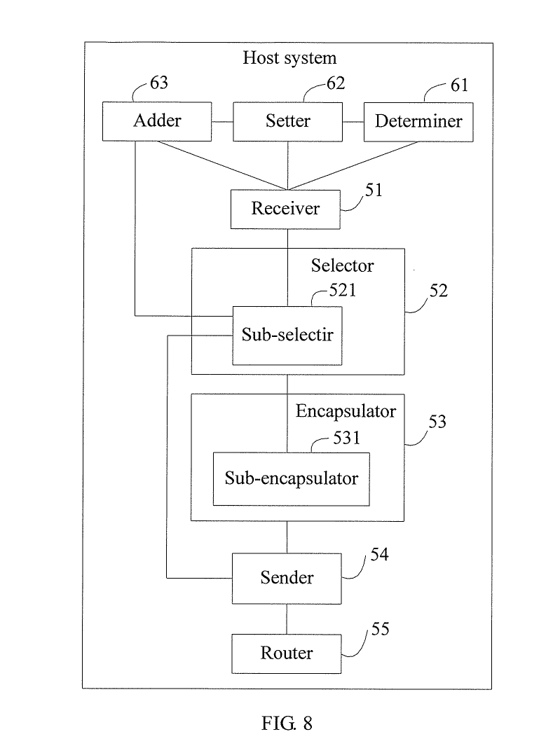

Further, as shown in FIG. 8, the encapsulator 53 further includes a sub-encapsulator 531, where the sub-encapsulator 531 is configured to encapsulate the payload into an IP packet, where a source IP address in the IP packet is a source IP address corresponding to the actual routing path selected by the selector 52, and a destination IP address in the IP packet is a destination IP address corresponding to the actual routing path selected by the selector 52.

The sub-encapsulator 531 encapsulates, according to a source IP address and a destination IP address that are in routing information selected by the sub-selector 521, the payload received by the receiver 51, so that the sender 54 sends the encapsulated packet to the router 55.

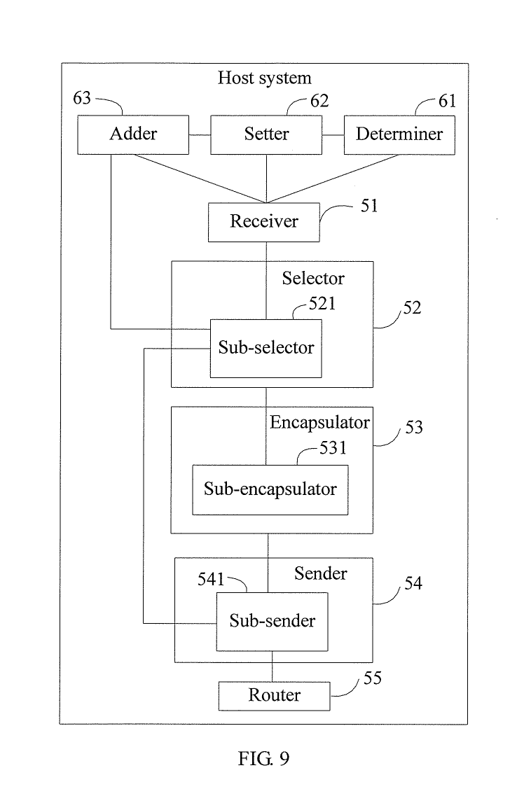

Further, as shown in FIG. 9, the sender 54 further includes a sub-sender 541.

The sub-sender 541 is configured to send, according to the actual routing domain number corresponding to the actual routing path selected by the sub-selector 521, the IP packet encapsulated by the sub-encapsulator 531 to a routing domain corresponding to the router 55.

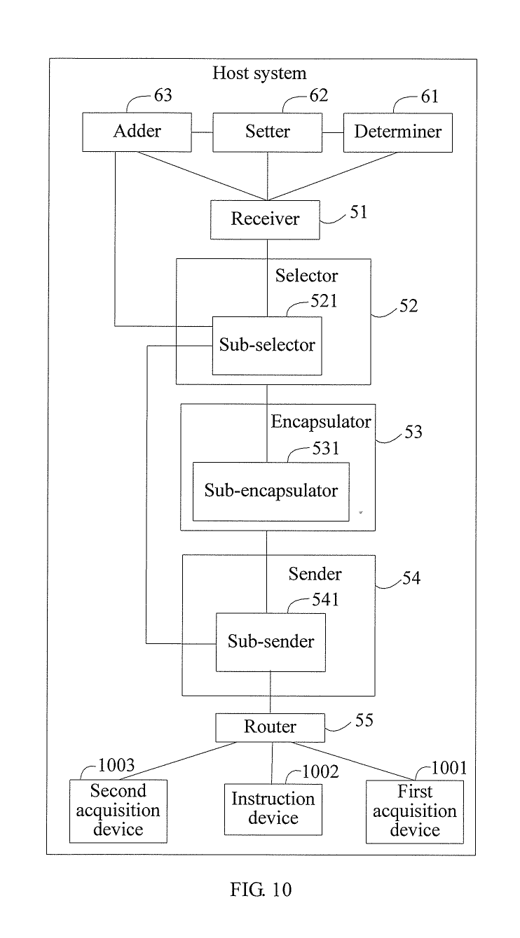

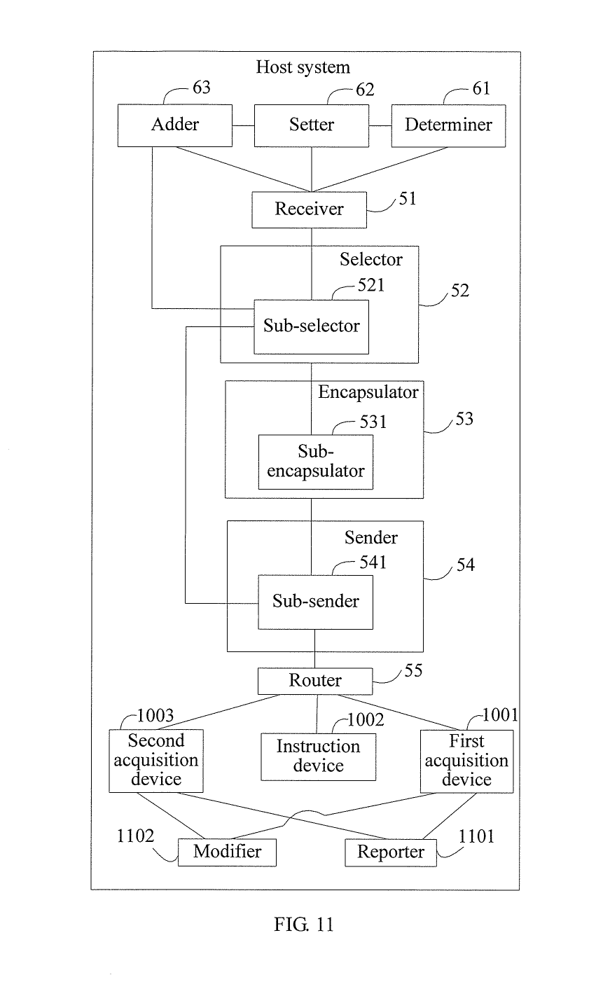

Further, as shown in FIG. 10, the host system further includes a first acquisition device 1001, an instruction device 1002, and a second acquisition device 1003.

The first acquisition device 1001 is configured to acquire first routing state information that is used by the router 55 to route the packet, where the first routing state information is used to indicate whether a routing path for routing the packet is reachable.

The instruction device 1002 is configured to instruct the router 55 to route a testing packet to the target host system.

The second acquisition device 1003 is configured to acquire second routing state information that is used by the router 55 to route the testing packet, where the second routing state information is used to indicate whether a routing path for routing the testing packet is reachable.

When an IP packet sent by the router 55 of a source host system carries a feedback instruction (where the feedback instruction is used to instruct a target base station to return, to a source base station, information used for indicating whether the IP packet reaches the target base station, that is, routing state information), the router 55 of the target host system sends another IP packet including routing state information of the IP packet to the source host system. The routing state information is the first routing state information. In this case, the first acquisition device 1001 of the source host system receives the other IP packet. Alternatively, the instruction device 1002 of the source host system instructs the router 55 to send the target host system a testing IP packet used for testing a reachable state of the routing path. The second acquisition device 1003 of the source host system receives another testing IP packet including routing state information of the testing IP packet, where the other testing IP packet is a response testing IP packet fed back by the target host system according to the testing packet sent by the source host system. Information that is in the other testing IP packet and is used to indicate a path reachable state is the second routing state information.

Further, as shown in FIG. 11, the host system further includes a reporter 1101 and a modifier 1102.

The reporter 1101 is configured to: after the first acquisition device 1001 acquires the first routing state information and/or the second acquisition device 1003 acquires the second routing state information, report, to an upper layer of a transport layer, the destination IP address corresponding to the routing path, the actual routing domain number corresponding to the routing path, and a reachable state of the routing path according to the first routing state information and/or the second routing state information.

The modifier 1102 is configured to: after the first acquisition device 1001 acquires the first routing state information and/or the second acquisition device 1003 acquires the second routing state information, modify the relational table according to the first routing state information and/or the second routing state information, where the modifying the relational table includes deleting the routing path in the relational table and adding the routing path to the relational table.

When an application layer of the source host system needs to test a reachable state of an IP packet, the reporter 1101 reports, to the application layer, the first routing state information acquired by the first acquisition device 1001, where the first routing state information is used to indicate a transmission condition of a packet; when the application layer of the source host system needs to test the reachability of a routing path, the reporter 1101 reports, to the application layer, the second routing state information acquired by the second acquisition device 1003, where the second routing state information is used to indicate the reachability of a single routing path. When the source host system needs to test the reachability of all routing paths in a whole network, the reporter 1101 and the second acquisition device 1003 can acquire reachable state information of all the routing paths of the whole network by repeating the step of acquiring the second routing state information. In addition, the modifier 1102 can add and delete path information in the relational table for maintenance and testing of the source host system.

The receiver 51, the selector 52, the encapsulator 53, the sender 54, the determiner 61, the setter 62, the adder 63, the instruction device 1002, the reporter 1101, and the modifier 1102 correspond to the transport layer in the foregoing method embodiments, and the router 55, the first acquisition device 1001, and the second acquisition device 1003 correspond to the network layer in the foregoing method embodiments.

In the host system provided in this embodiment of the present invention, a transport layer can select a routing path for payloads of a wholesale operator and a retail operator, encapsulate the payloads into packets, and send the packets to a network layer, so that the network layer sends the packets to a target host system. Because when the routing path is selected for the payloads, a routing path of any routing domain instead of a routing path of a dedicated routing domain can be selected for routing, that is, no dedicated routing domain is designated for an operator, the wholesale operator and the retail operator are not limited by a routing domain. Because the operator has no dedicated routing domain, priority routing policies of routing domains can be unified, thereby avoiding that a routing domain of the wholesale operator routes a packet of the retail operator according to a priority routing policy of the wholesale operator when the packet of the retail operator is routed by using the routing domain of the wholesale operator, which therefore can implement independent QoS management and traffic statistics performed by the operators. Meanwhile, more desirable resource space is provided for communication between a host system and a controller, thereby improving a communication speed between a host system and a controller. The retail operator can autonomously control and detect a packet transmission condition by selecting a path by the transport layer, and for a packet which does not belong to a routing range of a routing domain of the retail operator, the retail operator no longer bears an extra service, that is, an extra service burden of the retail operator is reduced. In addition, because the transport layer can select the routing path for the payloads of the wholesale operator and the retail operator, so that an application layer can differentiate different routing domains in the network layer without dividing the application layer, so as to achieve an objective of selecting different routing domains for routing, and further the application layer can simultaneously receive the payload of the wholesale operator and receive the payload of the retail operator, that is, the application layer is not isolated according to an operator, so that an air interface resource in the application layer can be shared. Compared with a second technical solution in the prior art, the operators can use a same air interface resource, thereby improving configuration efficiency of air interface resources. Meanwhile, this embodiment of the present invention further provides an implementation manner of detecting the reachability of the routing path, thereby achieving technical effects of enhancing a management function of the transport layer, improving invoking efficiency of the application layer, and improving the packet transmission reachability.

The host system in this embodiment of the present invention includes, but is not limited to, a base station, an AP, or a multimedia device.

It may be clearly understood by a person skilled in the art that, for the purpose of convenient and brief description, division of the foregoing function modules is used as an example for illustration. In an actual application, the foregoing functions can be allocated to different modules and implemented according to a requirement, that is, an inner structure of an apparatus is divided into different function modules to implement all or part of the functions described above. For a specific working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the division of modules or units is merely logical function division and may be other division in actual implementation. For example, a plurality of units or components may be combined or integrated into another system, or some features maybe ignored or not performed. Furthermore, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

Moreover, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server or a network device) or a processor to perform all or a part of the steps of the methods described in the embodiments of the present invention. The foregoing storage medium includes: any medium that can store program code, such as a USB flash drive, a removable hard disk, a read-only memory (ROM), a random access memory (RAM), a magnetic disk or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A packet transmission method applied to a host system, the method comprising:
selecting, by a transport layer, a routing path for a received payload according to a preset relational table;
encapsulating, by the transport layer, the payload into a packet according to the routing path; and
sending, by the transport layer, the packet to a network layer according to the routing path, for sending the packet to a target host system.

2. The method according to claim 1, wherein before selecting, by a transport layer, a routing path for a received payload according to a preset relational table, the method further comprises:
receiving, by the transport layer, a first mapping table, wherein the first mapping table is used to indicate a correspondence between a source Internet Protocol (IP) address with a source routing domain number corresponding to the source IP address and a correspondence between a destination IP address with a destination routing domain number corresponding to the destination IP address;
when the source routing domain number is equal to the destination routing domain number, setting, by the transport layer, one of the source routing domain number and the destination routing domain number as an actual routing domain number; and
adding, by the transport layer, the source IP address, the destination IP address, and the actual routing domain number into the relational table, for establishing a routing path, and adding a path number for the routing path.

3. The method according to claim 2, wherein selecting, by a transport layer, a routing path for a received payload according to a preset relational table comprises:
selecting, in the relational table by the transport layer according to a preset algorithm and the path number, a routing path for routing the payload to serve as an actual routing path.

4. The method according to claim 3, wherein encapsulating, by the transport layer, the payload into a packet according to the routing path comprises:
encapsulating, by the transport layer, the payload into an IP packet, wherein a source IP address in the IP packet is a source IP address corresponding to the actual routing path, and a destination IP address in the IP packet is a destination IP address corresponding to the actual routing path.

5. The method according to claim 4, wherein sending, by the transport layer, the packet to a network layer according to the routing path comprises:
sending, by the transport layer, the encapsulated IP packet to a routing domain in the network layer according to the actual routing domain number corresponding to the actual routing path.

6. The method according to claim 1, further comprising:
acquiring, by the transport layer, first routing state information that is used by the network layer to send the packet, wherein the first routing state information is used to indicate whether a routing path for routing the packet is reachable.

7. The method according to claim 1, further comprising:
instructing, by the transport layer, the network layer to send a testing packet to the target host system, and acquiring second routing state information that is used by the network layer to send the testing packet, wherein the second routing state information is used to indicate whether a routing path for routing the testing packet is reachable.

8. The method according to claim 1, further comprising:
acquiring, by the transport layer, first routing state information that is used by the network layer to send the packet, wherein the first routing state information is used to indicate whether a routing path for routing the packet is reachable; and
instructing, by the transport layer, the network layer to send a testing packet to the target host system, and acquiring second routing state information that is used by the network layer to send the testing packet, wherein the second routing state information is used to indicate whether a routing path for routing the testing packet is reachable.

9. The method according to claim 6, wherein after acquiring, by the transport layer, the first routing state information, the method further comprises at least one of following steps:
reporting, by the transport layer, to an upper layer of the transport layer, the destination IP address corresponding to the routing path, the actual routing domain number corresponding to the routing path, and a reachable state of the routing path according to the first routing state information; and
modifying, by the transport layer, the relational table according to the first routing state information, wherein modifying the relational table comprises: deleting a routing path in the relational table or adding a routing path to the relational table.

10. The method according to claim 7, wherein after acquiring, by the transport layer, the second routing state information, the method further comprises at least one of following steps:
reporting, by the transport layer, to an upper layer of the transport layer, the destination IP address corresponding to the routing path, the actual routing domain number corresponding to the routing path, and a reachable state of the routing path according to the second routing state information; and
modifying, by the transport layer, the relational table according to the second routing state information, wherein modifying the relational table comprises: deleting a routing path in the relational table or adding a routing path to the relational table.

11. A host system, comprising:
a receiver, configured to receive a payload;
a selector, configured to select, according to a preset relational table, a routing path for the payload received by the receiver;
an encapsulator, configured to encapsulate, according to the routing path selected by the selector for the payload, the payload received by the receiver into a packet; and
a sender, configured to send the packet encapsulated by the encapsulator to a router, for sending the packet to a target host system.

12. The host system according to claim 11, wherein:
the receiver is further configured to receive a first mapping table, wherein the first mapping table is used to indicate a correspondence between a source IP address with a source routing domain number corresponding to the source IP address and a correspondence between a destination IP address with a destination routing domain number corresponding to the destination IP address; and
the host system further comprises:
a determiner, configured to determine whether the source routing domain number and the destination routing domain number are equal,
a setter, configured to: when a determining result of the determiner is that the source routing domain number is equal to the destination routing domain number, set one of the source routing domain number and the destination routing domain number as an actual routing domain number, and
an adder, configured to add, into the relational table, the source IP address, the destination IP address, and the actual routing domain number that is set by the setter, for establishing a routing path, and adding a path number for the routing path.

13. The host system according to claim 11, wherein the selector comprises:
a sub-selector, configured to select, in the relational table according to a preset algorithm and the path number that is added by the adder, a routing path for routing the payload to serve as an actual routing path.

14. The host system according to claim 13, wherein the encapsulator comprises:
a sub-encapsulator, configured to encapsulate the payload into an IP packet, wherein a source IP address in the IP packet is a source IP address corresponding to the actual routing path selected by the selector, and a destination IP address in the IP packet is a destination IP address corresponding to the actual routing path selected by the selector.

15. The host system according to claim 14, wherein the sender comprises:
a sub-sender, configured to send, according to the actual routing domain number, the IP packet encapsulated by the sub-encapsulator to a routing domain corresponding to the router.

16. The host system according to claim 11, further comprising:
a first acquisition device, configured to acquire first routing state information that is used by the router to send the packet, wherein the first routing state information is used to indicate whether a routing path for routing the packet is reachable.

17. The host system according to claim 16, further comprising:
an instruction device, configured to instruct the router to route a testing packet to the target host system; and
a second acquisition device, configured to acquire second routing state information that is used by the router to send the testing packet, wherein the second routing state information is used to indicate whether a routing path for routing the testing packet is reachable.

18. The host system according to claim 16, further comprising:
a reporter, configured to: after the first acquisition device acquires the first routing state information, report, to an upper layer of a transport layer, the destination IP address corresponding to the routing path, the actual routing domain number corresponding to the routing path, and a reachable state of the routing path according to the first routing state information; and
a modifier, configured to: after the first acquisition device acquires the first routing state information, modify the relational table according to the first routing state information, wherein the modifying the relational table comprises deleting a routing path in the relational table or adding a routing path to the relational table.

19. The host system according to claim 17, further comprising:
a reporter, configured to: after the first acquisition device acquires the second acquisition device acquires the second routing state information, report, to an upper layer of a transport layer, the destination IP address corresponding to the routing path, the actual routing domain number corresponding to the routing path, and a reachable state of the routing path according to the second routing state information; and
a modifier, configured to: after the first acquisition device acquires the second acquisition device acquires the second routing state information, modify the relational table according to the second routing state information, wherein the modifying the relational table comprises deleting a routing path in the relational table or adding a routing path to the relational table.
